(19) United States
(12) Patent Application Publication
(10) Pub. No.: US 2003/0182284 A1
(43) Pub. Date: Sep. 25, 2003

(54) Dynamic data mining process

(76) Inventor: Lucian Russell, Alexandria, VA (US)

Correspondence Address: GREENBERG & LIEBERMAN, 314 PHILADELPHIA AVE., TAKOMA PARK, MD, 20912, US

(21) Appl. No.: 10/105,910

(22) Filed: Mar. 25, 2002

(51) Int. Cl. G06F 17/30

(52) U.S. Cl. 707/6

(57) ABSTRACT

The invention “Dynamic Data Mining Process” provides a systematic, controlled and rational means to increase the number of valid relationships found within collections of data by focusing on the data most likely to be sound, and selectively using the remaining data to increase the likelihood that initially detected candidates for rules are meaningful patterns vs. random co-occurrences of values.

### 1.0 BACKGROUND

1.1 Overview

The most famous maxim in the field of Computer Science is “Garbage In Garbage Out” (GIGO) this applies to sub-field of Data Mining as well. In Data Mining, the objective of the rule discovery technique is to find meaningful rules—mathematical relationships among values of variables for which data is collected—which have been heretofore unknown.

The problem faced by persons using existing processes to extract rules is that an extremely large number of rules that apply to small amounts of data can be discovered, but the relationships may not be meaningful. Rules are logical statements or mathematical formulae that predict the value of some variables based upon the value of others. In a collection of data, however, for small subsets of data some rules may appear that are there by chance. The word formulae, multiple formulas, is often substituted for rules when the data involved is all numeric.

The meaning of this last statement is illustrated by what can happen in the process of building a table of variables using a random number generator. Suppose that three variables X, Y and Z are given values by means of selecting a random value from one of three corresponding probability distributions. The numbers would not represent any real world phenomenon. However, it is likely that there will be small groupings of values that will be representable by a formula: for 0.0001% of the triples of values X−Y+Z=3. This would clearly not be meaningful. When data is taken from the real world, however, we do not know if that relationship is meaningful or not.

In order to make it less likely that rules discovered in data mining are just random occurrences of groups if values the current practice if to perform data cleaning. A meaningless relationship is “Garbage Out”, and this will be less likely if bad data can be eliminated up front, “Garbage IN”. In the next section the current state of the practice is reviewed. However, as will become clear this eliminates 100% of questionable data, which has a side effect of throwing away data Lilat might be helpful in determining if rules formulae are meaningful.

The invention “Dynamic Data Mining Process” provides a systematic, controlled and rational means to increase the number of valid relationships found within collections of data by focusing on the data most likely to be sound, and selectively using the remaining data to increase the likelihood that initially detected candidates for rules are meaningful patterns vs. random co-occurrences of values. The discussion is taken from set of non-copyrighted course notes posted on the World Wide Web in 2001 from a course on Data Mining a recent course given by David Squire, Ph.D. David Squire teaches at the Australian University of Monash in Queensland, Australia. It summarizes well the state of the practice at the current time. The major refernce work for all data cleaning is [Pyle 99].

1.2 Current Approaches to Data Preparation

Before starting to use a data-mining tool, the data has to be transformed into a suitable form for data mining. Although many new and powerful data mining tools have become available in recent years, but the law of still applies:

Garbage In [symbol] Garbage Out

Still applies. Good data is a prerequisite for discovery or rules and formulae that are meaningful. The process of creating a clean dataset involves a number of steps. The first is to access the data from at its sources, transferring it to the computer where the data mining process will be run, converting it to a suitable format (e.ge. creating common field names and lengths), converting to common formats (e.g. units of measurement), and eliminating data values that appear to be in error. Some example:

Capitalization: convert all text to upper- or lowercase. This helps to avoid problems due to case differences in different occurrences of the same data (e.g. the names of people or organizations

Concatenation: combine data spread across multiple fields e.g. names, addresses. The aim is to produce a unique representation of the data object

Representation formats. Some sorts of data come in many formats, e.g. dates—12/05/93, 05—Dec- 93. Ttransform all to a single, simple format

Some useful operations during data access/preparation are:

Augmentation: remove extraneous characters e.g. !&%$#@ etc.

Abstraction: it can sometimes be useful to reduce the information in a field to simple yes/no values: e.g. flag people as having a criminal record rather than having a separate category for each possible crime

Unit conversion: choose a standard unit for each field and enforce it: e.g. yards, feet->meters.

Some difficulties may also exist because of problems of granularity—summary data from some sources and detail data from other sources There may also be problems with consistency. Inconsistency within and among data sources can defeat any data mining technique until it is discovered and corrected. Some examples:

different things may have the same name in different systems

the same thing may be represented by different names in different systems

inconsistent data may be entered in a field in a single system, e.g. auto_type: “Merc”, “Mercedes”, “M-Benz”, “Mrcds”

Data pollution is also a big problem. Data pollution can come from many sources. One of the most common is when users attempt to stretch a system beyond its intended functionality, e.g. the use of “B” in a gender field, intended to represent “Business”. The field was originally intended to only even be “M” or “F” but rather than change the program recording the data the filed was redefined to include neutral entities. Other sources of error in real data sets include:

copying errors (especially when forrnat incorrectly specified)

human resistance—operators may enter garbage if they can't see why they should have to type in all this “extra” data.

Other issues are more related to the semantics of data. For example, what data is being recorded if one source of data is recording “consumer spending” and another is recording “consumer buying patterns”. Another set of issues is understanding values in a data table as they relate to the real world restrictions of data values. These issues are known as those of domains of values, or domain, i.e.:

Every variable has a domain: a range of permitted values

Summary statistics and frequency counts can be used to detect erroneous values outside the domain

Some variables have conditional domains, violations of which are harder to detect, e.g. in a medical database a diagnosis of ovarian cancer is conditional on the gender of the patient being female

Some data is also generated as a default value when the real data values are not known. It is important to known if the system has default values for fields, this must be known. Conditional defaults can create apparently significant patterns which in fact represent a lack of data.

Another issue is data integrity. Checking integrity evaluates the relationships permitted between variables e.g. an employee may have multiple cars, but is unlikely to be allowed to have multiple employee numbers.

Another issue is the existence of duplicate or redundant variables. Redundant data can easily result from the merging of data streams. It occurs when essentially identical data appears in multiple variables, e.g. “date_of_birth” “age”. If the data values are not actually identical, reconciling differences can be difficult

Some data sources may be too large. One approach is to take a random samle of all the data. Another is to eliminate some data:

data processing takes up valuable computation time, so one should exclude unnecessary or unwanted fields where possible

fields containing bad, dirty or missing data may also be removed

Data Abstraction is also useful: information can be abstracted such that the analyst can initially get an overall picture of the data and gradually expand in a top-down manner. This will also permit processing of more data: it can be used to identify patterns that can only be seen in grouped data, e.g. group patients into broad age groups (0-10, 10-20, 20-30, etc.). Clustering can be used to fully or partially automate this process.

### 2.0 DYNAMIC DATA MINING PROCESS: THE KEY NOVEL IDEA

The dynamic data mining process starts with the novel idea that data cleanup should be a process performed on a sliding scale rather than on an all or nothing basis. The reason is that a decision to exclude data from consideration is an instance of reasoning under uncertainty. If it is not 100% percent clear that data should be excluded from a dataset then there is the risk that valuable data may be lost. If decisions about data inclusion or exclusion are made on a sliding scale, then it is possible to start with the most certain data, find possible rules, and then relax the required amount of uncertainty to see if the rules apply tot smaller or larger datasets. If the rules are random instances of data patterns they should start to fade—apply to smaller sized datasets.

In the following description we look at the entire process of taking data and using it to make discoveries of rules. This entire process, which includes data cleaning as a part, is called Knowledge Discovery in Databases (KDD). The rule discovery technique in data mining is a standard technique for which many tools are available. It is used in inductive data mining—inferring patterns from data by direct examination. The idea's compliment—deductive data mining—was put into the public domain by Lucian Russell in May 1998 [Russ 98]. The dynamic data mining process uses both of these in a novel manner; it is the invention.

Specifically, the technique described below creates intervals of uncertainty and categorizes the data as being in an interval. If the uncertainty used standard Pascalian probability [Kolm 50], then it would be intervals of probability, e.g. [1.0 to 0.90), [0.90 ]to 0.80) etc to [0.10 to 0.0] where the “[ ]” are standard mathematical symbols for closed interval boundaries (=> or <=) and “( )” are the same for open interval boundaries (< or >). The idea is that one starts n the most probable collection of data, the [1.0,0.90) data, and expand to include more data.

The above idea has one dimension, so the process looks trivial. Data Mining, however, is performed on datasets with tens, even hundreds of variables represented as data columns in a table. These tables are often the built by merging identical tables from different data sources or cross referencing data from multiple sources by joining on common data vales (relational database joins). There are as a consequence hundreds or thousands of ways of expanding from the most certain to less certain data. However, rules in data mining applying to a subset have two associated measure. If the rule is If P then Q it is possible to look at what percentage of the possible search space contains this rule, and then look at the surrounding space and take ratios:

Confidence: %-age of P & Q (i.e. Q\hat{ }P) w.r.t. P being true.

Goal Coverage: %-age of P & Q (i.e. Q\hat{ }A P) w.r.t. Q [symbol] P being true.

The rules discovered that apply to the greatest percentage of the data are ranked, and the search space is expanded in the direction of the variables in that rule, e.g. those three out of 100 possible. If the Confidence and Goal Coverage remain the same or increase in the new space, i.e. the data space including the data in those variables of the rule in which there is less confidence, then this rule is more likely to be meaningful. The space is expanded for variable of all rules with high percentages of data being correct. The advantage is that computations start on a small set of data and expand. It is dynamic in that the data alone determines the direction of the expansion, and it can alter as new variables are taken into account.

### 3.0 DEDUCTIVE AND DYNAMIC DATA MINING

This section first describes the technology of deductive data mining and how it is extended to dynamic data mining.

3.1 Deductive Data Mining: Completing the KDD Cycle

The prospect of obtaining new knowledge from databases has given rise to a new field of research, data mining. Databases may track data of previously unsuspected patterns of behavior of the entities that are described therein. The goal of data mining is to unleash algorithms that identify these patterns and report them back to the user. In reading serious treatments of data mining, however, the point is emphasized that data mining is only part of a larger cycle of activity, called Knowledge Discovery in Databases (KDD). According to [FAYY 96], this cycle includes “data warehousing, target data selection,”cleaning, preprocessing, transformation and reduction, data mining, model selection (or combination), evaluation and interpretation, and finally consolidation and use of the extracted “knowledge”. Although these steps are present, a better understanding of their motivation would be useful in determining how to make the data mining step more effective.

The current approach to data mining is an inductive one. Induction is a process that is not well understood even outside the computer field. Its pure logical form is ((∃x)F(x))→(∀x)Fx)) or what is true for some is true for all. Deduction, on the other hand, is that process that determines “If P then Q”, or in set theoretical terms the set in which P is true is contained in the set in which Q is true. Although deduction is usually presented as a type of logical operation, in actual practice outside mathematics it is used to structure scientific inquiry, in which not all data points support the proposed deduction 100%. Thus, in fact both inductive data mining and scientific deduction look for rules of the form:

“IF P THEN Q WITH RELATIVE FREQUENCY=Y>X” (Eq. 1)

This allows us to introduce the term “deductive data mining”. Whereas inductive data mining varies rules to find the best fit on data, deductive data mining varies the data to find the best fit for rules. A practicing scientist using deduction starts out with a hypothesis about the data, then looks for ways to explain the discrepancies, data that does not fit the rule. Although tweaking the rules is one way of improving the situation, the most often used technique is to “explain away” the discrepancies. This takes the form of finding reasons to reject certain data points, or find common features that lead to subsetting or clustering data. To do this requires managing the uncertainty of the data. Thus deductive data mining organizes the first part of the KDD process by structuring the inquiry about what data is to be mined by applying the principles of Evidential Reasoning. These allow the target data selection, cleaning, preprocessing, transformation and reduction steps to be performed as part of a controlled process. As such they provide a methodology that organizes the steps outside data mining in a rational manner. The result however, also enhances inductive data mining. If bad data is eliminated, the value of Y in Equation (1) may very likely be increased.

3.1.1 The Deductive Part of the KDD Cycle

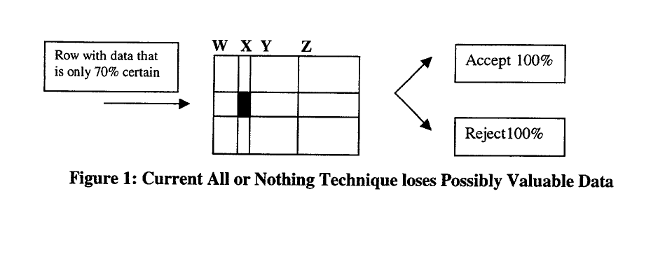

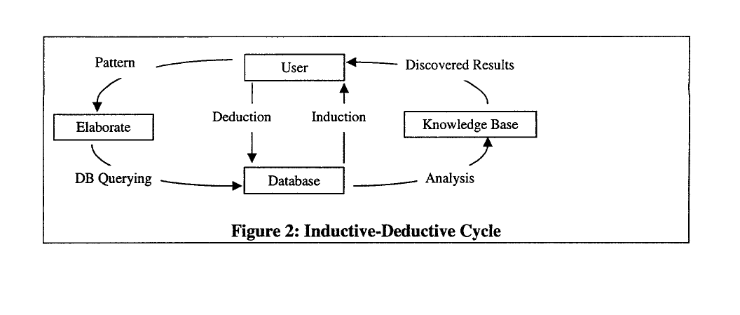

The concept of a cycle of induction and deduction was introduced in [KERO 95] in the form shown in FIG. 2. The left-hand side is the deductive part of the cycle; the following KDD steps are part of this “deductive” processes.

Target data selection: Why is certain data in a database selected for data mining? The data collectively has a meaning, semantics, with respect to some real world situation about which the user wants a greater understanding. This is clearly the application of some knowledge to the data, a setting of assumptions about the real world. If a relation has attributes A,B,C,D,E,F,G then when the projection B,D,G is selected as the target data the assumption is also that A,C,D,E do not contain rules of interest. The attributes B,D,G become “relevant variables”. Of course, upon iteration in the KDD cycle one of the originally omitted attributes may be added, showing an uncertainty about the selection B,D,G, i.e. that the scope in the selection assumption was too narrow.

Cleaning: This is the first recognition that not every data item is equal to every other, a recognition that there is some uncertainty about the data. Cleaning actually is two processes, the elimination of data and its reconstitution. The methodology of this process is materially enhanced by the application of Evidential Reasoning [SCHU 94], and is a critical part of the deductive data mining process that can benefit from computerized support. The elimination of data takes the form of deleting rows in a relation that do not meet certain integrity criteria. Data reconstitution is guessing at what the data should be. This obviously introduces new uncertainties into the data when done by computer. This is where a methodology must be introduced, but currently is totally lacking.

Pre-Processing and Transformation: This is a catch-all for the creation of derived data. Critical to the process is the question of why the transformations are made. Some are made for purely syntactic reasons: a view is to be created and a join cannot take place without attributes that are in the same logical domain, e.g. units of measure, critical dates. Others are made again as assumptions about the relevant variables, i.e. that the ratio of attributes A and B will produce results of interest, not the attributes themselves. This is clearly in line with traditional scientific discovery techniques.

Reduction: This process reduces the volume of data. Although seemingly a practical step, this is actually a step that uses the mathematics of statistics to control uncertainty. Reduction consists of taking a sample of the database for use by the inductive data mining algorithms. The assumption used is from sampling theory, that the part has a probability of being similar to the whole. When an inductive relationship is discovered, then a new sample is taken to see if the rules in the one are corroborated at the same relative frequency levels in others. If not, the rule is a local aberration. If so it is more likely to be a rule that is true on all of the data.

In all of the above steps the human mind is at work, selecting assumptions, relevant variables, cleaning and reconstitution rules and generally preparing what is expected to be a set of “likely data” for data mining. The process could use some methodological support. Expert Decisions Inc.'s technology has this, and is developing tools to provide it.

3.1.2 How is Deduction Used?

Deduction is used in several ways. First, deduction is a mental process of the user that frames a hypothesis about the data, and then sets about using assumptions, theorems and the data to validate the hypothesis. Second it is used to control the amount of data that is to be used in the data mining step by restricting it to data that has a known degree of certainty, starting with the most certain data and adding in additional data values as appears useful. Thirdly, it is the process of screening data to be excluded or reconstituted.

3.1.2.1 Deduction as Validating a Hypothesis

Although this is not the use of deduction that occurs in geometry, it is the process used in law and medicine and scientific inquiry. The user queries a view. Let the hypothesis be that P→Q on a given view of data S with M rows. The user queries the database to find the relative frequency N/M of the data where P→Q is true. Then the relative frequency of the data where

˜(P→Q) is true is (M−N)/M. This can be restated as:

“IF P THEN Q WITH RELATIVE FREQUENCY=N/M”

which is exactly the form of a rules that is discovered with inductive data mining.

3.1.2.2 Deduction as a Banding Process

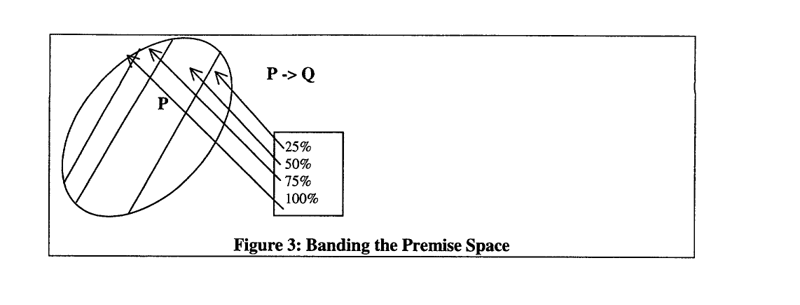

The process of performing uncertainty management can be used in a more directed manner than is current practice. Consider the space of all premise data in the database S used to prove the hypothesis. By using a measure of uncertainty it is possible to divide up the space into bands of decreasing certainty, as shown in FIG. 3. These can be used to further reduce the search space used in the data mining phase as well.

3.1.2.3 Deductive Database: The Foundations

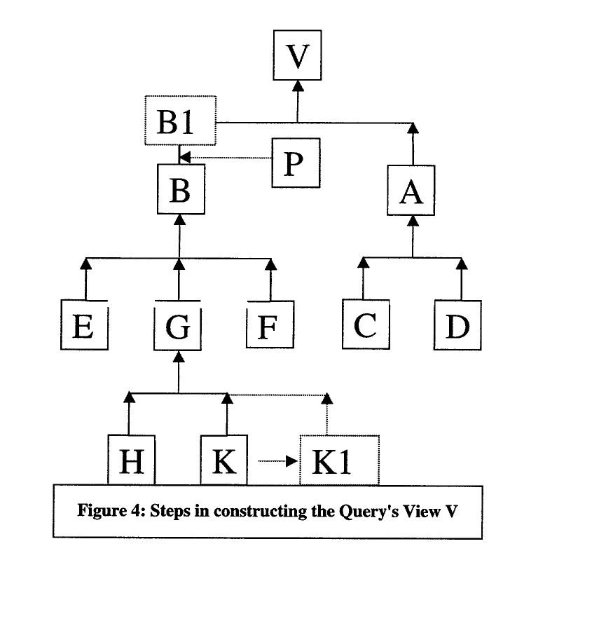

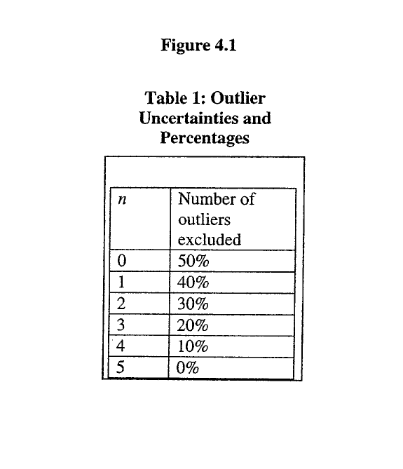

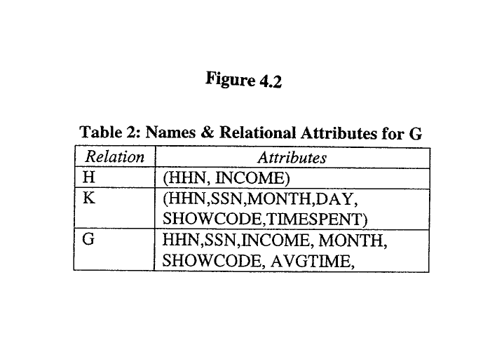

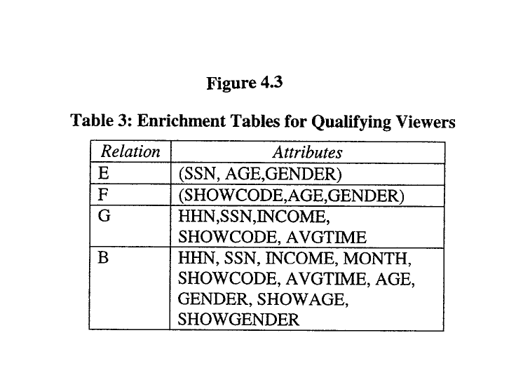

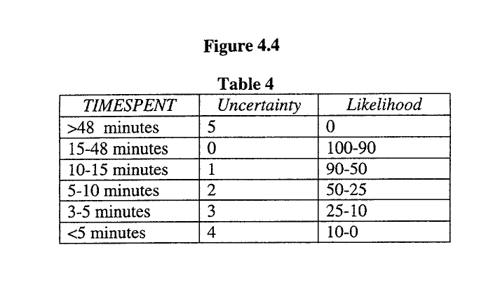

The discussion provided above does not yet distinguish deductive data mining from simple querying. That distinction is now described. In deductive data mining there is a query submitted to the database. By careful use of transformations and relational operations a relational view can be constructed that allows this query to be executed on a single table. The heart of the matter is what data is to be contained in the table. Taking the cue from scientists, no hypothesis about data should be tested against data that has not previously been thoroughly analyzed for validity. Every collection of data is scrutinized and deemed more or less certain to be free from error. This means, however, there is a rule that assigns a measure of uncertainty to the data, a rule based on a set of assumptions about the domain of the data and the means of data collection. Of course the hypothesis represented by the query may change, but this aspect of the process will not be discussed because the focus is on the data. Let V be the final view, a join of two views A and B, where A is a three way join of C,D and E and B is a two way join of F, and G; G is further assumed to be a two-way join of H and K. This is shown in FIG. 4.

FIG. 4's block diagram shows the flow of data without any reasoning about its validity. Assuming that all the data is valid, we can see that the steps have the same form as an argument, i.e. if we accept H and K, then G follows, and if . . . etc. Now consider the case when the data is screened for validity. This means that a measure Ri is applied at each arrow. The rule takes the form:

“Assuming hypotheses {Hᵢ}, then CASE

If (expression₁ on attributes of relation R) THEN uncertainty band value=0

If (expression₂ on attributes of relation R) THEN uncertainty band value=1

Etc. . . . ”

In other words, the data that makes up V upon which the query is run depends on the data in A and B, etc..

The words hypothesis and query have been used interchangeably. This is because [Reit 84] proved that a query on a relation can be considered a mathematical proof about the data in the database, provided three assumptions can be met. The hardest of these is that that there is no other data that might be used. For any given state of the database this is true, but updates may invalidate the assumption. Data mining, however, occurs on static databases. The issue of the impact of updates is discussed in Section 3.4.

If a hypothesis is the same as a query, how is this viewed in practice? Assume the view V has attributes a,b,c,d,e,f and let an example query be:

SELECT * FROM V WHERE ((A=1) AND (B>2) AND (F=“UPPER LEFR QUADRENT”))

The hypothesis is then formulated in set theory as a tuple exists within a cross product V satisfying the logical condition:

(∃(x,y,s,t,z)∈V) [symbol] ((x=1)\hat{ }(y>2)(z=“UPPER LEFT QUADRENT”))

Similarly, when V is built up from A and B there is a matching condition on the join variables.

3.1.2.4 Deduction and Uncertainty Measures

The uncertainty measure is one that determines what part of the data shall be used and what part shall be discarded. One well-known measure is probability. For example, if a database contains the scores of individuals on standardized tests, and the scoring is based on a previously measured normal distribution of the population, one uncertainty measure, such as in the famous Scholastic Aptitude Tests (SAT) score, could be measured in terms of the standard deviation σ. The score of 500 is the mean μ, a score of 600 is for one standard deviation σ from μ, 700 is for 2*σ deviations σ from μ, and 800 for 3* σ and above deviations σ from μ. Another uncertainty measure concerns statistics but is not based on probability theory: means and outliers. The algorithm provides that a certain absolute number of outliners may be designated for purposes of computing the mean of a sample of data. This number could be parameterized as 10%, 20% up to 50% of the sample, yielding a 5-value scale. For any given relation, this measure may result in an additional criterion added to the WHERE clause. In SQL [Date 89] this would mean a clause like “AND WHERE X>600”.

The second measure, however, is more complex. First of all the measure depends totally on the data in the attribute of interest. Consider the example of the relation U with attributes a,b,c,w. Let the attribute whose mean is selected be w, and the statistic in question be the mean of all w's, i.e. “SELECT AVG(W) FROM U”, and let “COUNT(*) FROM U” return the value N. One way of handling the situation is to transform the data into a new relation U1 with new attributes m,n i.e. the relation U1 has attributes a,b,c,w,m,n. In this example m represents the mean for the uncertainty values tagged by n, and n is the value on the uncertainty scale shown in Table 1.

3.1.2.5 An Example Database

Now let us look at how the uncertainty measures combine by taking a hypothetical database of television viewing habits. Each household in the study is assigned a number (HHN), and the Social Security Number (SSN) of each participant is given. Each person is given their own remote and turns shows on and off. There is an algorithm used to eliminate the impact of channel surfing during commercials. Of interest is the time spent watching the shows (identified by SHOWCODE), specifically do people stop watching after they see the start of the show. If so advertisers at the end of the show are not getting the same audience as at the start of the show, and their advertising rates must be lowered. Only shows watched from the beginning are tracked. Let H be a table of annual family income, with HHN identifying the household. Let K be a list of times during the day that television was watched. Then G is a list with the average amount of television per week and per family member. The transformation is:

CREATE VIEW G HHN, SSN, INCOME, MONTH, SHOWCODE, AVGTIME FROM K, H HHN, SSN, INCOME, SHOWCODE, AVG(TIMESPENT)

WHERE K.HHN=H.HHN GROUP BY SSN, MONTH

The relation G tells how many hours each person in the family spends in a given month watching each show.

The television station, however, do not want to give back any money, so they are very concerned about the accuracy of this data. It is possible that there is bad data, so they bring in two more tables. The first E one is a family member category table. It shows age group and gender for each SSN in the group. The elderly and children should have different patterns of watching. The second one F is a likelihood, based on focus groups that a given gender and age will watch the show. What is of concern here is whether the family members mixed up the remotes and used the wrong one. Then B is computed with a number of new attributes:

CREATE VIEW B HHN, SSN, INCOME, MONTH, SHOWCODE, AVGTIME, AGE, GENDER, SHOWAGE, SHOWGENDER FROM E,F,G

HHN, SSN, INCOME, MONTH, G.SHOWCODE, AVGTIME, E.AGE, E.GENDER, F.AGE, F.GENDER WHERE G.SSN=E.SSN=F.SSN

This is further combined with regional information and prices in A, using C and D, that we will ignore, except that A can yield a projection of SHOWCODE,TIMEVIEWED. Each show has a certain number of commercial minutes and the remainder is TIMEVIEWED, the actual show time (e.g. 7 Eastern, 6 Central). The view V is then used for a query:

SELECT COUNT(SHOWCODE), MONTH FROM V WHERE (AVGTIME<TIMEVIEWED) GROUP BY MONH

This is a hypothesis about the data, that the pattern of “short viewing” exists. What is unknown is how well the data supports the hypothesis. This is obtained by comparing the results with the total number of possible shows for that SHOWCODE in the month,

SELECT COUNT(SHOWCODE),MONTH FROM V GROUP BY MONTH

and taking the ratio of the former to the latter. Assume that the query shows a ratio of 25%.

3.1.2.6 Applying Deductive Data Mining

The television companies decide to subject the data in B to further analysis. Specifically they will try to deduce whether it is getting data that represents our assumptions about the real world, vs. data that contains “erroneous” behavior with respect to the intended query. See Table 4. Starting at the beginning, the data in K is examined in more detail. Based on a-priori knowledge of television watching, the executives start with a time period of 15 minutes and above as being a bound for higher levels of certainty, using the rationale that a person will at least find out what a show is about before not watching it. Also there is an upper bound of 48 minutes, because at least 12 minutes of commercials per show are sold, and if not the time is filled in with public service announcements or previews of the stations' next shows. Numbers above this are errors. Then they assign intervals for TIMESPENT.

The above information if then appended to the relation K, to create K1 using an embedded-SQL like program that will perform the operation:

CREATE VIEW KI

HHN,SSN,MONTH,DAY, SHOWCODE, IMESPENT, UNCERTAINTY FROM K WHERE CASE

IF (15<TIMESPENT<=48)THEN UNCERTAINTY=0;

IF (10<TIMESPENT<=15)THEN UNCERTAINTY=1;

IF (5<TIMESPENT<=10) THEN UNCERTAINTY=2;

IF(3<TIMESPENT<=5) THEN UNCERTAINTY=3;

IF (0<TIMESPENT<=3) THEN UNCERTAINTY=4;

DEFAULT UNCERTAINTY=5;

This changes the definition of G to initially read:

CREATE VIEW G HHN, SSN, INCOME, MONTH, SHOWCODE, AVGTIME FROM K1, H HHN, SSN, INCOME, SHOWCODE, AVG(TIMESPENT) WHERE K1.HHN=H.HHN AND UNCERTAINTY=0 GROUP BY SSN, MONTH

The data are subsequently examined under the hypothesis that the certainty is less than or equal to 1,2,3,4,and 5.

3.1.2.7 Cascading Measures of Uncertainty

In the above example, now consider one more measure of uncertainty and see how they combine with the time-validation measure just proposed. We will make one more assumption, that the number of shows has been reduced, say to the number that are either in use by an advertiser or those where advertising is planned. Assume further that the network has done focus groups who would watch the show and provide a likelihood that they would view it based on age and gender. This work has resulted in a table of probabilities that a viewer is of a given age and gender. The table is a new one P with attributes SHOWCODE, AGE, GENDER, RELFREQ.

Given this table there is a new filter introduces onto the table B. A new relation B1 is created with an additional column UNCERTAINTY. The value of UNCERTAINTY is determined as follows

WHERRE

P.AGE=B.AGE AND P.GENDER=B.GENDER AND P.SHOWCODE=B.SHOWCODE

CASE

IF (66<RELFREQ<=100) THEN UNCERTAINTY=1;

IF (AGE=SHOWAGE) AND (GENDER=SHOWGENDER) THEN UNCERTAINTY=0

IF ((AGE≈SHOWAGE) OR (GENDER≈SHOWGENDER)) THEN CASE IF (33<RELFREQ≦66) THEN UNCERTAINTY=2;

DEFAULT UNCERTAINTY=3;

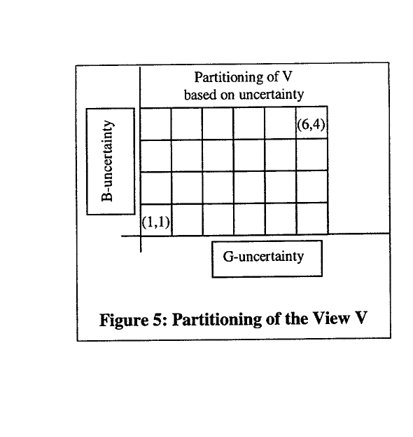

This creates a 4-value scale for the data. If the person watching the show was age and gender appropriate, then the data is accepted with the lowest uncertainty. If either the age or gender differed from the target age and gender, the uncertainty was higher and based on the relative frequency measures (expressed as whole percentages rounded to integers). Screening for different values of integrity have a marked effect on the amount of data in V and its characterization, as shown in FIG. 5. The actual number of effected tuples could be shown as a 3-D bar column whose height depends on the actual data. Another viewpoint could be a cumulative one, showing how the amount of data was increased by each relaxation of the certainties.

3.1.2.8 The Distinction and its Difference

The discussion in the previous section was provided to illustrate an important technical advance, the mixing of heterogeneous uncertainty measures. Throughout this discussion of deductive data mining we have used the work “uncertainty” rather than the more popular “probability”. The distinction is important to understand, because if probabilities are used as both the name of and model for measures of uncertainty unwanted side effects crop up. In the discussion that follows we will assume finite sets, because all databases are finite.

First, consider what is a probability. As J. Cohen points out in [Cohe 89] the mathematics of what we call Pascalian probability has been well developed since Kolmogorev's [Kolm 50] work in 1933 (the 50 in the reference is for he English translation]. However, the application of probability theory to the real world requires an interpretation, of which there are six major ones and perhaps even more of some interest. Simplifying the domain to finite sets allows one to choose the Relative Frequency interpretation, but leaves open the question of whether probability is Bayesian or not. The traditional approach to Probability sees data as a sample of a random process, and we seek to estimate the probability of the sample given the statistics (e.g. mean, standard deviation) of the distribution. The Bayesian approach sees data as confirming or denying a hypothesis. It reverses the prior approach, and estimates the probability of the statistics given the sample. Which ever interpretation is made, however, the net effect is the same for the data: each data point (e.g. tuple) is assigned a probability so that the sum of the probabilities=1.

The lure of mathematical probability is that the probability of a collection of items may be inferred by knowing the probability of each of them. If a probability

(a) had been assigned to relations K,

(b) inherited in G, and

(c) further, one had been assigned to relation P, then

(d) each tuple in V could have a computed probability that was the product of those computed for the V's attributes derived from G and P.

The mathematical power of this approach has caused many to insist that Pascalian probability is the only valid uncertainty measure. Behind this insistence is the fear that admitting non-Pascalian probabilities would mean that the uncertainty measures could not be combined. Our method shows that this is not true.

In set theory, especially finite set theory, equivalence exists between an intensional or logical description or a property P and an extensional description, i.e. enumeration of all elements in the set. When non-Pascalian uncertainty measures are applied to a database in the manner above, by uncertainty intervals, it becomes possible to combine any types of uncertainty measures. This is sometimes characterized as an implicit function, as is the case when a functionf has no inverse in a closed form¹. ¹ This means that no formula could be defined for f⁻¹, but if (a) one can tell the points that f was mapped from, and (b) there are no many to one mappings, then the points in the set of f⁻¹ values defines a function by enumeration.

Another advantage is that this technique disambiguates types of uncertainty. Using a probability measure on would use a low probability, say 0.01 that that a 5-6 year old would watch a program for senior citizens, but they might watch it because the characters remind them of the grandparents. This is an infrequent but valid event. On the other hand if the non-commercial (i.e. program) watched time on a for-profit TV station was 56 minutes, this too could have a probability of 0.01 because no company would allow that much time on a show without identifying its sponsorship. This is an event that is very likely to be erroneous. In the standard means of combining probabilities the two events could combine, for a probability of 0.0001 or 1 in ten thousand, but the same probability is assigned regardless of the meaning of the probability. By using the bands, if more uncertain data were admitted into V it could be done so that at the maximum the data that is highly uncertain because it is erroneous could be screened out! In FIG. 5 that means never using data with the highest G-uncertainty, the rightmost column of the graph.

3.2 Deductive and Inductive: Dynamic Data Mining

The goal of (inductive) data mining is to find rules about the data that apply a certain percentage of the time in the database. Although the desired relative frequency is 100%, this is seldom achieved. Also, within the set of rules that are returned some are obvious. This situation is to be avoided, so the data mining literature cites the condition that only “interesting or unusual” patterns should be reported. No criteria are given for “interesting” or “unusual” other than the relative frequency measure already cited, so relative frequency is used as a substitute. Without a systematic use of deduction on the start of the KDD cycle, however, software can discover an enormous number of “rules” that are true sometimes. Limiting the search space in a more systematic way could make the activity more productive. This gives rise to the idea of dynamic data mining, alternatively using deduction and induction.

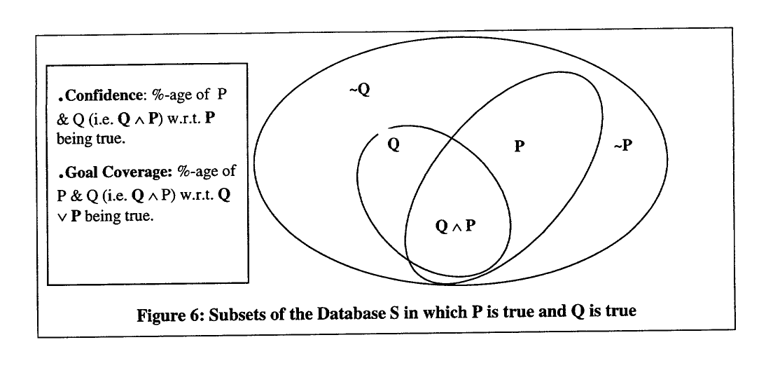

Consider the spaces where conditions P and Q are valid for the Database S, shown in FIG. 6. There is some overlap of P and Q, and its extent is measured by the confidence factor. The set of values for (PQ) is also shown. When the inductive data mining technique of rule discovery is used, Q is a user chosen condition on a dependent variable (attribute), and the goal is to identify conditions P on the independent variables (attributes). In other words a typical Q is of the form “R.A₄=Q₁” for relation R where Q₁ is a value. If the data for attribute A₄ is continuous, a new interval variable I₄ is set up, and values from A₄ are grouped together in these intervals.

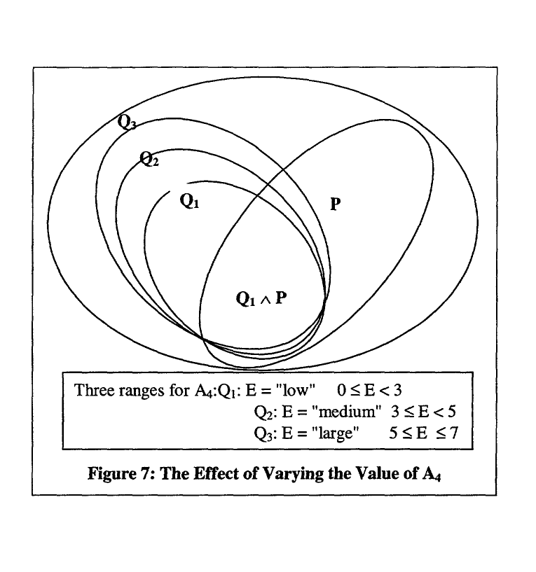

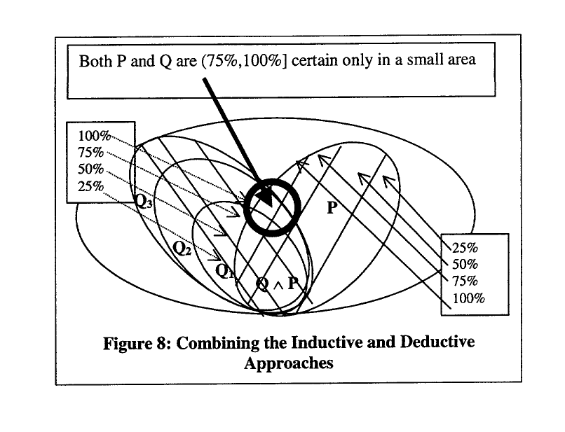

If different values, Q₂ and Q₃ were selected, the rule for P would cover a different amount of area, as shown in FIG. 7.

In this Figure there are three ranges for the attribute A₄. The ovals are extensions, and do not represent a subset or a “contained-in” condition. Clearly the confidence factor for rule P is higher for condition Q₁ than for Q₂ and Q₃.

Still, coming up with these rules represents a large amount of processing time in a very large space S. We now consider what happens when uncertainty measures are introduced.

Assume that inductive data mining was performed and the rule P->Q (A₄=Q₁) was found to be a candidate rule. Then the data in P and Q was subjected to a deductive process, culminating in bands of certainty for both P and Q (those in P are the same as in FIG. 3). If the process is re-run on the most certain data first, a higher confidence factor for the rule will be found. Additional amounts of data than may be dynamically added to the set to be mined. Notice the ratios of the areas are far different when all of the data is used than is true when some of the data is used. This is one way of finding more “unusual” rules, as a more intensive data mining activity can be unleashed on this smaller subset of the original set S.

In the example a condition P is shown for three different values of Q. In most data mining systems for rule values the inductive rule system would be looked at in terms of multiple values of P which might be independent. The threshold for rule validity might be set so high, in fact, that the confidence factors for Q₂ and Q₃ would fall below them. If the value Q₁ were determined by some mathematical algorithm this might be acceptable, but in reality the value is set by the user. Suppose the interval [5,11] was chosen. This choice is likely to be a guess. Let Q₂ be the lower range [2,4] and Q₃ the higher range [12,15]. Queries on the variables of P and Q could reveal that [4,12] was really the range where the rule had highest confidence.

3.3 Controlling the Search Space Expansion

The example in the previous section leads very well into the issue of how the user controls the dynamic data mining steps. The user is the controller case because of the issue of “interesting” rules. There are many rules that are obvious, that are of no interest. One might find, for example, that in an address list the set of values {NE, SE, SW, NW} appear associated with the city Washington D.C. This will be a rule with high confidence (almost nowhere else in the country) but not “interesting”. Therefore for a general-purpose system since only some rules revealed by data mining are of interest a way to tag these rules and interact with them is needed.

In rule discovery the form of the rule is that values of certain attributes occur together with the value or range of values for the dependent attribute. Let the view V on which data mining is performed have attributes (a₁,a₂, . . . a₁₅), and let a₁₅ be the dependent variable. Let the attributes in Rule 1, an “interesting” rule, be a₂, a₄, a₇, a₁₂, a₁₃. Of interest for this rule then is whether more data in these attributes may strengthen the rule. As there may be multiple origins of the uncertainties in V, it is important to be able to trace back to the relations that supplied the data in the attribute set {a₂, a₄, a₇, a₁₂, a₁₃}. These may even be the key attributes in join, so their values go back to several other relations. Supporting this exploration requires knowing the Chain of Reasoning that led up to the view V.

The Chain of Reasoning is the object created in the Reasoning Validation System to create the view V, including all of the validation steps. It is therefore also the control mechanism for expanding the uncertainty bands to include more uncertain data (the Chain of Reasoning is described in the Requirements Specification, as is the exact specification of the process of performing Dynamic Data Mining). This is necessary because in addition to logical issues there are performance issues, especially on very large databases.

The expansion of V is the expansion of the number of tuples in the relations A and B whose join makes up the view. Because of the nature of joins, a 10% increase in the number of new records in A or B may result in a much larger increase in the number of records in V. This is true all the way back to relations H and KI. New records coming from K1 will increase the size of G, which will increase the size of B, again in a content-dependent manner. If the joined relations are distributed, communications cost will be a major factor, perhaps requiring the advance transfer of remote files to a local relational table. Some help, however can be provided the user. Products such as the IBM DB2 database provide Application Programming Interface as well as a windows interface to the database engine's query optimizer. The RVS system, therefore, provides for generating time estimates and making them available to the user. Thus a step that is less time consuming can be sequenced prior to a step that requires more processing time.

### 4.0 REFERENCES

[AhG97] I. Ahmad and W. I. Grosky, “Spatial Similarity-Based Retrievals and Image Indexing by Hierarchical Decomposition,” Proceedings of the International Database Engineering and Application Symposium, Montreal, Canada, August 1997, pp. 269-278.

[ATY95] Y. A. Aslandogan, C. Their, C. T. Yu, and C. Liu, “Design, Implementation”and Evaluation of SCORE (a System for Content based Retrieval of pictures), Proceedings of the 11^{th} IEEE International Conference on Data Engineering, Taipei, Taiwan, March 1995, pp. 280-287.

[BPS94] A. Del-Bimbo, P. Pala, and S. Santini, “Visual hnage Retrieval by Elastic Deformation of Object Shapes,” Proceedings of the IEEE Symposium on Visual Languages, October 1994, pp. 216-223

[ChG96] . Chaudhuri and L. Gravano, “Optimizing Queries over Multimedia Repositories,”Proceedings of SIGMOD ″96, Montreal, Canada, June 1996, pp. 91-102.

[ChW92] C.-C. Chang and T.-C. Wu, “Retrieving the Most Similar Symbolic Pictures from Pictorial Databases,” Information Processing and Management, Volume 28, Number 5 (1992), pp. 581-588.

[Cohe 89] L. Jonathan Cohen, “An Introduction to the Philosophy of Induction and Probability,” Clarendon Press, Oxford, 1989

[CSY86] S.-K. Chang, Q.-Y. Shi, and S.-W. Yan, “Iconic Indexing by 2D Strings,” Proceedings of the IEEE Workshop on Visual Languages, Dallas, Tex., June 1986, pp. 12-21.

[Date 89] C. J. Date, “A Guide to the SQL Standard”, Second Edition, Addison Wesley, Reading Mass.

[DuH73] - .O. Duda and P. E. Hart, Pattern Classification and Scene Analysis, John Wiley and Sons, Inc., New York, N.Y., 1973.

[GrJ94] W. I. Grosky and Z. Jiang, “Hierarchical Approach to Feature Indexing,” Image and Vision Computing, Volume 12, Number 5 (June 1994), pp. 275-283.

[Gro97] W. I. Grosky “Managing Multimedia Information in Database Systems,” Communications of the ACM, Volume 40, Number 12 (December 1997), pp. 72-80.

[ChL84] S.-K. Chang and S.-H. Liu, “Picture Indexing and Abstraction Techniques for Pictorial Databases,” IEEE Transactions on Pattern Analysis and Machine Intelligence, Volume 6, Number 4 (July 1984), pp. 475-484.

[FAYY 96] Fayaad, U., Piatetsky-Shapiro, G. and Smyth, P. Eds. Data Mining to Knowledge Discovery: an Overview in Advances in Knowledge Discovery and Data Mining, MIT Press 1996.

[GFJ97] W. I. Grosky, F. Fotouhi, and Z. Jiang, “Using Metadata for the Intelligent Browsing of Structured Media Objects,” In Managing Multimedia Data: Using Metadata to Integrate and Apply Digital Data, A. Sheth and W. Klas (Eds.), McGraw Hill Publishing Company, New York, 1997, pp. 67-92.

[Gud95] V. Gudivada, “On Spatial Similarity Measures for Multimedia Applications,” Proceedings of IS&T/SPIE: Storage and Retrieval for Image and Video Databases III, San Jose, Calif., February 1995, pp. 363-372.

[HSE95] J. Hafner, H. S. Sawhney, W. Equitz, M. Flickner, and W. Niblack, “Efficient Color Histogram Indexing for Quadratic Form Distance Functions,” IEEE Transactions on Pattern Analysis and Machine Intelligence, Volume 17, Number 7 (July 1995), pp. 729-736.

[HuJ94] P. W. Huang and Y. R. Jean, “Using 2D C⁺-Strings as Spatial Knowledge Representation for Image Database Systems,” Pattern Recognition, Volume 27, Number 9 (1994), pp. 1249-1257.

[KERO 95] Kero, R., Russell L, S. Tsur, W-M Shin, An Overview of Database Mining, Proceedings of the KDOOD Workshop, Singapore December 1995.

[Kolm 50] A. Kolmogorev, Foundations of the Theory of Probability, trans. N. Morrison, Chelsea Publishing Company, New York, 1950

[Pyle 99]. Dorian Pyle, Data Preparation for Data Mining,, Morgan Kaufmann Publishers, 1999.

[Oro94] J. O″Rourke, Computational Geometry in C, Cambridge University Press, Cambridge, England, 1994.

[Reit 84] R. Reiter, “A Logical Relational Database Theory” in On Conceptual Modelling, Ed. Michael Brodie, John Mylopoulos, Joachim W. Schmidt, Springer Verlag, New York, 1984pp. 191-238

[Russ 98] L. Russell, Deductive Data Mining: Uncertainty Measures for Banding the Search Space, Proceedings of the 5^{th} International Workshop on Knowledge Representation Meets Databases (KRDB '98), Report 18, Seattle Wash., May 1998, Swiss Life Information System Research, Zurich Switzerland

[SCHU 94] Evidential Foundations of Probabilistic Reasoning, D. Schum, John Wiley & Sons, New York, 1994

[SmB95] S. M. Smith and J. M. Brady, SUSAN—A New Approach to Low-Level Image Processing, Technical Report TR-95SMS1c, Department of Clinical Neurology, Oxford University, United Kingdom, 1995.

[Stok 69] J. J. Stoker, “Differential Geometry”, Wiley Interscience, New York 1969

[Ston 99] M. Stonebraker, Paul Brown with Dorothy Moore, Object-Relational DBMSs—Tracking The Next Great Wave, 2^{nd} Edition Morgan-Kaufmann Publishers, San Francisco, 1999.

[WMB94] I. H. Witten, A. Moffat, and T. C. Bell, Managing Gigabytes, Van Nostrand Reinhold, New York, N.Y,, 1994.

I claim:

1. The invention shown and described.
